(19) United States
(12) Patent Application Publication
(10) Pub. No.: US 2021/0350774 A1
(43) Pub. Date: Nov. 11, 2021

(54) REUSABLE AND REPOSITIONABLE ARTICLE

(71) Applicant: Joseph Eilert, Vernon, CT (US)

(72) Inventor: Joseph Eilert, Vernon, CT (US)

(21) Appl. No.: 17/308,216

(22) Filed: May 5, 2021

Related U.S. Application Data
(60) Provisional application No. 63/021,385, filed on May 7, 2020.

(51) Int. Cl. G10G 7/00

(52) U.S. Cl. CPC G10G 7/00

(57) ABSTRACT

An article for retaining an object against a musical instrument including a mat of a material that extends from a first surface to a second surface. The first surface contacts a contoured surface of the musical instrument and the second surface contacting the object. The mat flexes to match the contoured surface of the musical instrument. The static coefficient of friction of the first surface is greater than the static coefficient of friction of the contoured surface of the musical instrument. As a result, the mat removably retains the object on the contoured surface of the musical instrument.

### BACKGROUND

Guitar players must use both hands while playing the guitar. When playing music that the guitarist has not memorized, the musician uses sheet music or tablature to guide their playing. In the past, this sheet music and tablature was printed on paper and placed on a music stand in front of the guitarist. Recently, the popularity of mobile devices such as cell phones and tablets has brought about the creation of applications that provide musicians with music directly from their device. These devices are often smaller than a sheet of music and thus must be held closer to the musician to be at a comfortable reading distance. While playing guitar seated, one convenient location to place your phone is on top of the side of the guitar. In this position, the device is easily accessible and read from. Since guitars typically have smooth surfaces and mobile devices are made out of hard materials, the devices slide around and often fall off of the guitar.

There is a need in the art for an article that improves retention of devices made of hard, smooth materials and the smooth surfaces of guitars or the like. There is specifically a need for an article that is reusable and repositionable without damaging the surface of the guitars or the like or the mobile devices.

### SUMMARY

There is disclosed herein an article for retaining an object against a musical instrument. The article includes a mat of a material having a first static coefficient of friction. The mat extends from a first surface to a second surface. The first surface contacts a contoured surface of the musical instrument. The second surface contacts the object. The material of the mat flexes to match the contoured surface of the musical instrument. The first static coefficient of friction is greater than a second static coefficient of friction of the contoured surface of the musical instrument. The mat removably retains the object on the contoured surface of the musical instrument.

In one embodiment, the first surface has the first static coefficient of friction and the second surface has a third static coefficient of friction that is less than the first static coefficient of friction.

In one embodiment, the third static coefficient of friction is greater than the second static coefficient of friction.

In one embodiment, the first surface of the mat is removable from the contoured surface of the musical instrument without damaging or staining the contoured surface.

In one embodiment, the first static coefficient of friction of the mat remains the same following removal and reattachment of the first surface of the mat to the contoured surface of the musical instrument.

In one embodiment, the first surface and the second surface of the mat each have a mat surface area that is smaller than a surface area of the contoured surface of the musical instrument.

In one embodiment, the material of the mat is translucent.

In one embodiment, the material of the mat is nontoxic.

In one embodiment, the mat extends a mat thickness from the first surface to the second surface. Compression of the mat thickness improves retention of the object to the contoured surface of the musical instrument.

In one embodiment, the musical instrument is fully functional when the first surface contacts the contoured surface of the musical instrument and the second surface contacts the object.

### BRIEF DESCRIPTION OF THE DRAWINGS

The drawings show embodiments of the disclosed subject matter for the purpose of illustrating the invention. However, it should be understood that the present application is not limited to the precise arrangements and instrumentalities shown in the drawings, wherein:

FIG. 1 is an isometric view of a musical instrument and a mat according to the present disclosure;

FIG. 2 is a partial isometric view of a musical instrument and a mat according to the present disclosure;

FIG. 3 is a partial isometric view of the musical instrument and mat of FIG. 2 including an object compatible with the mat of the present disclosure;

FIG. 4 is a partial side view of a musical instrument, a mat and an object according to the present disclosure;

FIG. 5 is a partial isometric view of the musical instrument and mat of FIG. 4 including two objects compatible with the mat of the present disclosure;

FIG. 6 is a partial isometric view of the musical instrument and mat of FIG. 4 including two objects compatible with the mat of the present disclosure; and

FIG. 7 is an isometric view of a musical instrument and two objects compatible with the mat of the present disclosure with the musical instrument in use.

### DETAILED DESCRIPTION

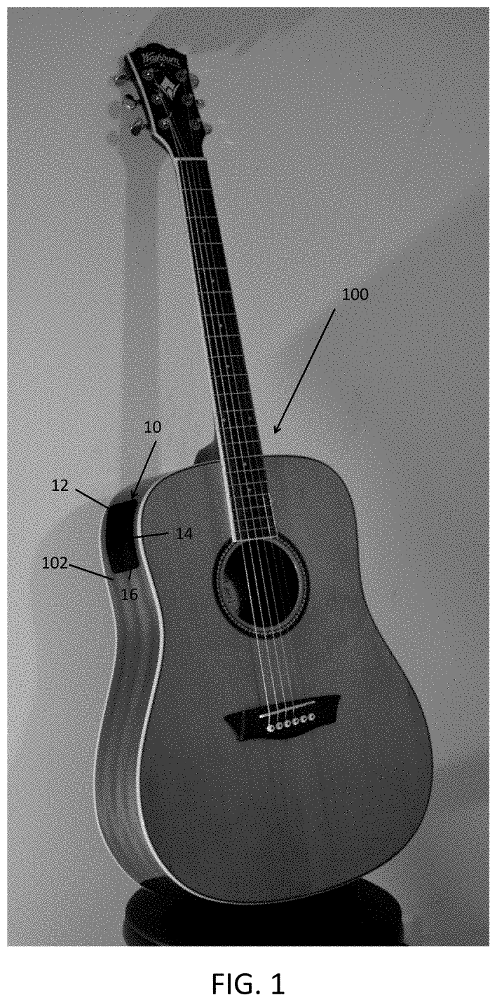

Referring to FIGS. 1-3, an article for retaining an object 110A (depicted in FIG. 3) against a musical instrument 100 is generally designated by the numeral 10. While a guitar is shown in the figures, it is contemplated that other instruments 100 may be used in connection with the invention, such as, e.g. a violin, a viola, a cello, a string bass, and the like.

Referring to FIG. 3, the article 10 includes a mat 12 of a material having a first static coefficient of friction μ1. The mat 12 extends from a first surface 14 to a second surface 16. The first surface 14 contacts a contoured surface 102 of the musical instrument 100. The second surface 16 contacts the object 110A and the material of the mat 12 allows the mat 12 to flex to match the contoured surface 102 of the musical instrument 100. The contoured surface 102 of the musical instrument 100 has a second static coefficient of friction μ2. The first static coefficient of friction μ1 is greater than a second static coefficient of friction μ2. The mat 12 removably retains the object 110A on the contoured surface 102 of the musical instrument 100.

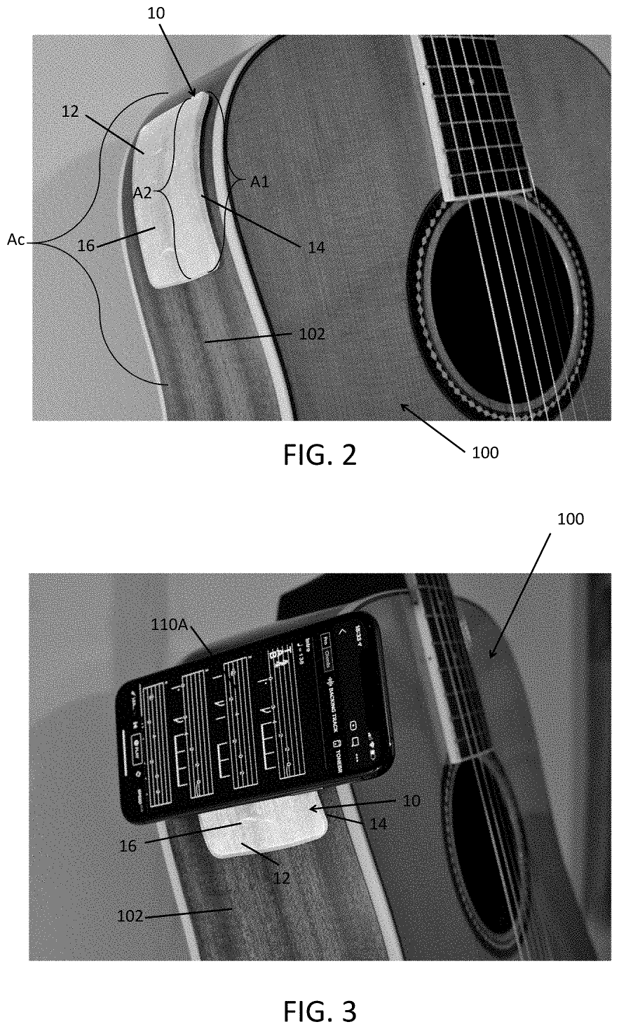

Referring to FIG. 2, the first surface 14 has the first static coefficient of friction μ1 and the second surface 16 has a third static coefficient of friction μ3. In the embodiment depicted in FIG. 2, the third static coefficient of friction μ3 is less than the first static coefficient of friction μ1. This relationship of the first static coefficient of friction μ1 and the third static coefficient of friction μ3 prevents the object 110A from becoming detached from the second surface 16 while also allowing the object 110A to be detached from the second surface 16 without removing the mat 12 from the contoured surface 102. The first static coefficient of friction μ1 and the third static coefficient of friction μ3 are both larger than the second static coefficient of friction μ2, ensuring that the mat 12 provides the necessary increased friction over that provided by the contoured surface 102. In one embodiment, the first static coefficient of friction μ1 and the third static coefficient of friction μ3 are equal to one another. In the embodiment depicted in FIG. 2, the first surface 14 and the second surface 16 of the mat 12 are each defined by a mat surface area A1, A2 that is smaller than a surface area Ac of the contoured surface 102 of the musical instrument 100. In the embodiment depicted in FIGS. 1-7, the first surface 14 and the second surface 16 of the mat 12 are defined by a substantially rectangular shape. Other shapes for the first surface 14 and/or the second surface 16, including but not limited to, a polygon, a circle, an oval, etc. do not depart from the invention disclosed herein.

Referring to FIG. 3, installing the mat 12 between the musical instrument 100 and the object 110A increases the friction between the musical instrument and the object 110A (e.g., a mobile device) by adding a soft rubberized interface in the form of the mat 12 that sits atop of the musical instrument (e.g., a guitar or other similar instrument).

In the embodiment depicted in FIGS. 1-7, the first static coefficient of friction μ1 of the mat 12 remains the same following removal and reattachment of the first surface 14 of the mat 12 to the contoured surface 102 of the musical instrument 100. As a result, the mat 12 is reusable on the same or different musical instruments. The first surface 14 of the mat 12 is removable from the contoured surface 102 of the musical instrument 100 without damaging or staining the contoured surface 102. The material of the mat 12 is translucent, transparent, opaque and/or nontoxic. In one embodiment, the first surface 14 and/or the second surface 16 of the mat 12 has an additional design, including but not limited to a logo, a brand or additional coloring. In one embodiment, the first surface 14 and/or the second surface 16 of the mat 12 has a surface finish, including but not limited to a checkerboard pattern, spaced bumps, grooves, or other physical extensions of the surface 14, 16.

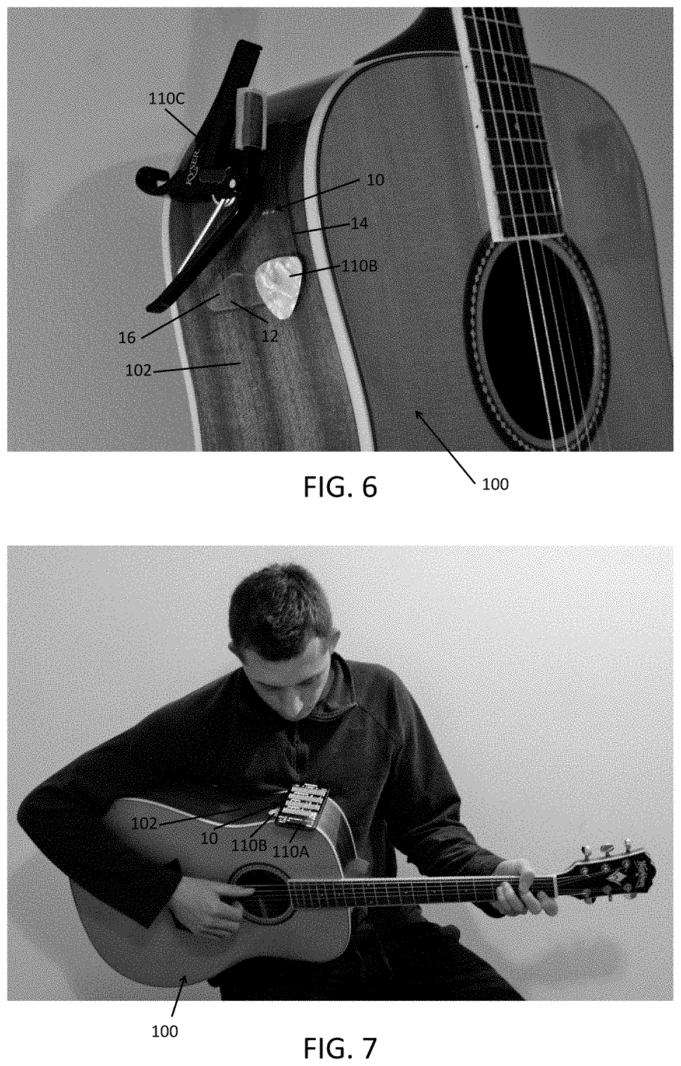

Referring to FIG. 5, the mat surface area A2 of the second surface 16 is larger than a surface area of the object 110A allowing the second surface 16 to retain a second object 110B simultaneously with the object 110A. The mat 12 is compatible with numerous objects. In the embodiment depicted in FIG. 6, the second surface 16 retains the second object 110B and a third object 110C. Examples of the object 110A, the second object 110B and the third object 110C include, but are not limited to, a cellular phone, a guitar pick, a capo, etc.

Referring to FIG. 7, the musical instrument 100 is fully functional when the first surface 14 contacts the contoured surface 102 of the musical instrument 100 and the second surface 16 contacts the object 110A. The mat 12 does not create any noises or otherwise impede the use of the musical instrument 100 during normal movement of the musical instrument 100 or object 110A.

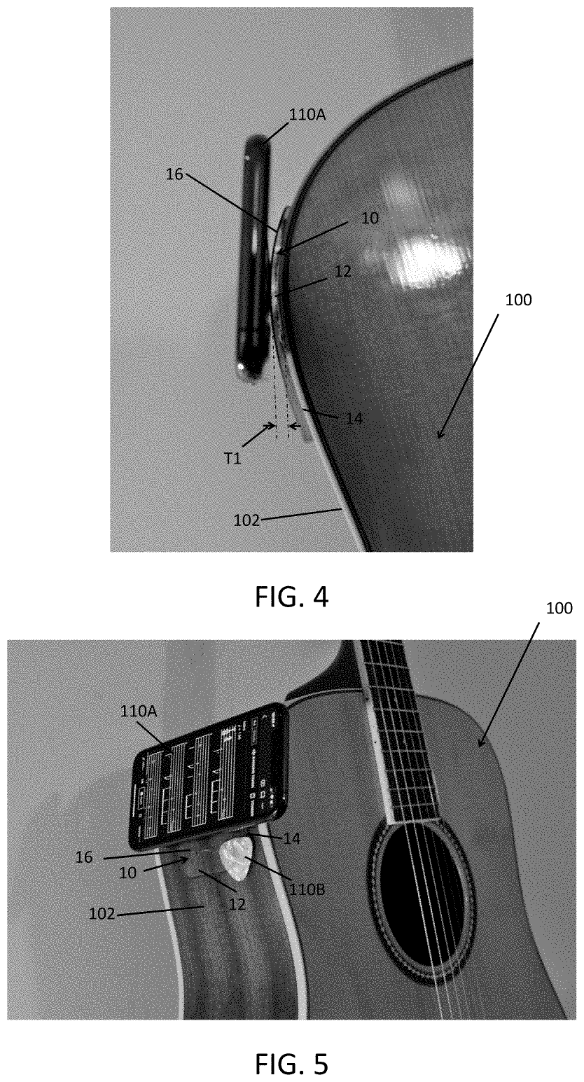

Referring to FIG. 4, the mat 12 extends a mat thickness T1 from the first surface 14 to the second surface 16. Compression of the mat thickness T1 improves retention of the object 110A to the contoured surface 102 of the musical instrument 100 by increasing the contact surface area between a flat surface of the object 110A and the curve of the contoured surface 102.

In some embodiments, the first surface 14 of the mat 12 is fixed to the contoured surface 102 of the musical instrument by other attachment means (e.g., magnets, hook and loop fasteners, snap fasteners, etc.). In some embodiments, the other attachment means are integrated into the musical instrument 100 itself by the original manufacturer of the musical instrument 100 or as a customization added to an existing musical instrument 100.

Although the disclosed subject matter has been described and illustrated with respect to embodiments thereof, it should be understood by those skilled in the art that features of the disclosed embodiments can be combined, rearranged, etc., to produce additional embodiments within the scope of the invention, and that various other changes, omissions, and additions may be made therein and thereto, without parting from the spirit and scope of the present invention.

What is claimed is:

1. An article (10) for retaining an object (110A) against a musical instrument (100), the article (10) comprising:
a mat (12) of a material having a first static coefficient of friction μ1, the mat (12) extends from a first surface (14) to a second surface (16), the first surface (14) contacting a contoured surface (102) of the musical instrument (100), the second surface (16) contacting the object (110A) and the material allowing the mat (12) to flex to match the contoured surface (102) of the musical instrument (100),
wherein the first static coefficient of friction μ1 is greater than a second static coefficient of friction μ2 of the contoured surface (102) of the musical instrument (100), and
wherein the mat (12) removably retains the object (110A) on the contoured surface (102) of the musical instrument (100).

2. The article (10) of claim 1, wherein the first surface (14) has the first static coefficient of friction μ1 and wherein the second surface (16) has a third static coefficient of friction μ3 that is less than the first static coefficient of friction μ1.

3. The article (10) of claim 2, wherein the third static coefficient of friction μ3 is greater than the second static coefficient of friction μ2.

4. The article (10) of claim 1, wherein the first surface (14) of the mat (12) is removable from the contoured surface (102) of the musical instrument (100) without damaging or staining the contoured surface (102).

5. The article (10) of claim 1, wherein the first static coefficient of friction μ1 of the mat (12) remains the same following removal and reattachment of the first surface (14) of the mat (12) to the contoured surface (102) of the musical instrument (100).

6. The article (10) of claim 1, wherein the first surface (14) and the second surface (16) of the mat (12) are each defined by a mat surface area (A1, A2) that is smaller than a surface area (Ac) of the contoured surface (102) of the musical instrument (100).

7. The article (10) of claim 1, wherein the material of the mat (12) is translucent.

8. The article (10) of claim 1, wherein the material of the mat (12) is nontoxic.

9. The article (10) of claim 1, wherein the mat (12) extends a mat thickness T1 from the first surface (14) to the second surface (16) and compression of the mat thickness T1 improves retention of the object (110A) to the contoured surface (102) of the musical instrument (100).

10. The article (10) of claim 1, wherein the musical instrument (100) is fully functional when the first surface (14) contacts the contoured surface (102) of the musical instrument (100) and the second surface (16) contacts the object (110A).
